(19) United States
(12) Patent Application Publication
(10) Pub. No.: US 2005/0100268 A1
(43) Pub. Date: May 12, 2005

(54) Low loss optical switch using magnetic actuation and sensing

(76) Inventors: Jack Foster, Los Altos, CA (US); Armand Neukermans, Portola Valley, CA (US); Brian Tremaine, San Jose, CA (US); Art Wagner, San Jose, CA (US)

Correspondence Address: JOHN C. GORECKI, ESQ., 180 HEMLOCK HILL ROAD, CARLISLE, MA, 01741, US

(21) Appl. No.: 10/400,852

(22) Filed: Mar. 27, 2003

Related U.S. Application Data
(60) Provisional application No. 60/368,300, filed on Mar. 27, 2002.

(51) Int. Cl. G02B 6/35

(52) U.S. Cl. 385/17; 385/16

(57) ABSTRACT

Apparatus and methods are disclosed for selectively positioning a collimator body. The apparatus comprises support means adjustably supporting the collimator body; and adjustment means for selectively adjusting the collimator body, the adjustment means comprising an actuator component having a driver coil and a magnetic structure with a first gap formed therebetween; wherein an electrical current through the driver coil of the actuator component causes the collimator body to move perpendicular to a magnetic field created by the magnetic structure of the actuator component. The method comprises supporting the collimator; and adjusting the collimator body using an actuator component having a driver coil and a magnetic structure with a first gap formed therebetween; wherein an electrical current through the driver coil of the actuator component causes the collimator body to move perpendicular to a magnetic field created by the magnetic structure of the actuator component.

### REFERENCE TO PENDING PRIOR APPLICATION

This application claims benefit of pending prior U.S. Provisional Patent Application Ser. No. 60/368,300, filed Mar. 27, 2002 by Jack Foster et al. for LOW LOSS OPTICAL SWITCH USING MAGNETIC ACTUATION AND SENSING, which is hereby incorporated herein by reference.

### FIELD OF THE INVENTION

This invention relates to optical switching apparatus and methods in general, and more particularly to actuation devices for optical switching.

### BACKGROUND OF THE INVENTION

Often it is desirable to have a relatively small switching fabric for a variety of purposes, such as optical add-drop or small switching fabrics for all-optical networks. A variety of techniques have been used for this purpose. For example, it is possible to use micromachined moving mirrors for free space optics switching devices. Typically, these mirrors are inserted between collimators so as to switch the beam between the collimators. Likewise, it is possible to move the fiber in front of the collimator lens and thereby steer the beam from one collimator to another. This actuation may be done by using piezoelectric, magnetic or other means. Or, conversely, the lens may be moved in front of a stationary fiber to achieve the same beam deflection, with similar actuation mechanisms, if desired.

It is important that any actuation mechanisms be not susceptible to vibrations that may be occurring in the operating environment of the switch. In this respect, it is generally preferred to use balanced rotational mechanisms, such as properly designed mirrors, which are not susceptible to linear vibrations. This is because virtually all vibrations which occur in the operating environment are translational in nature. Mirrors also have the advantage that any angular rotation is multiplied by two.

Most of the other systems described above, apart from mirrors, suffer adversely from these environmental vibrations and, hence, these systems require separate sensors and tight servo-controls to overcome environmental vibration problems. Systems that use relative movement of the fiber or the lens also suffer from the fact that the fibers are generally terminated with an 8 degree cut to avoid reflections. This configuration complicates effective coupling and, in turn, puts more stringent alignment requirements on the fiber and its motion.

Recently, a system has been introduced by Polatis which rotates the collimators with respect to each other. See, for example, International Patent Application No. PCT WO 01/50176 A1. A connection is made when the collimators are properly pointing at each other. The system described uses arrays of piezo-electric torsional actuators, and possibly sensors, to rotate the collimators with respect to each other. This system has good optical characteristics. However, piezo actuators typically require a high voltage power source, and are prone to large drifts. In addition, this system is also quite expensive per port.

It is, therefore, extremely desirable to construct a switching fabric that has very low loss, a low cost, and an ability to be expanded that can expand to a relatively large size (e.g. 256×256).

### SUMMARY OF THE INVENTION

A system of rotatable collimators is described, which are magnetically actuated and sensed. These collimators are oriented with respect to each other so that the undeflected beams converge in the center of the opposite fields, thereby reducing the required deflection angles by a factor of 2. A set of coils on the moving collimators interact with stationary permanent magnets such that rotation in two axes takes place. By measuring the inductance change of the coils, it is possible to measure the rotations of each coil, thereby providing a sensor output for the collimator, necessary to provide adequate positioning. The collimators are fixed, with the right orientation in an etched sheet which provides for the gimbal mounting of all these devices. The collimators are fixed at the center of mass so that no external reaction takes place when vibrations occur. The collimators used have very well controlled beam pointing abilities and are of the type described in U.S. patent application Ser. No. 09/715,917, which is hereby incorporated herein by reference. However, the tolerances on the rotatable pointing are substantially relaxed so as to provide inexpensive switching devices.

This invention provides for a novel optical switching apparatus, specifically apparatus for selectively positioning a collimator body, the apparatus comprising: support means adjustably supporting the collimator body relative to a first position; and adjustment means for selectively adjusting the collimator body from the first position to a second position, the adjustment means comprising an actuator component having a driver coil and a magnetic structure with a first gap formed therebetween, one of the driver coil and the magnetic structure being in attachment to the selectively positionable collimator body and the other one of the driver coil and the magnetic structure being in attachment to a fixed support in connection with the support means adjustably supporting the collimator body; wherein an electrical current through the driver coil of the at least one actuator component causes the collimator body to move in a direction perpendicular to a magnetic field created by the magnetic structure of the at least one actuator component.

This invention also provides for a novel optical switch, specifically a system for facilitating an optical cross-connect from a first region to a second region, the system comprising: a first collimator body and a second collimator body adjustably positioned at the first region and the second region, respectively, the first collimator body and the second collimator body each having a proximal end and a distal end, respectively, the proximal end of the first collimator body and the proximal end of the second collimator body being oriented toward one another, and first support means and second support means for adjustably supporting the first collimator body at a first position and the second collimator body at a second position, respectively; first adjustment means and second adjustment means for selectively adjusting the first collimator body from the first position to a third position and the second collimator body from the second position to a fourth position, respectively, the first adjustment means and the second adjustment means each comprising an actuator component having a driver coil and a magnetic structure with a gap formed therebetween, one of the driver coil and the magnetic structure of the first adjustment means being fixedly attached to the first collimator body and the other one of the driver coil and the magnetic structure of the first adjustment means being fixedly attached to the first support means, one of the driver coil and the magnetic structure of the second adjustment means being fixedly attached to the second collimator body and the other one of the driver coil and the magnetic structure of the second adjustment means being fixedly attached to the second support means; first current controller means and second current controller means for controlling a first electrical current and a second electrical current, respectively, the first current controller means selectively applying the first electrical current to the driver coil of the first adjustment means, the second current controller means selectively applying the second electrical current to the driver coil of the second adjustment means; first determiner means and second determiner means for determining a relative position of the first collimator body and a relative position of the second collimator body, respectively; and a first feedback loop and a second feedback loop connecting the first determiner means to the first current controller means and the second determiner means to the second current controller means, respectively.

In another embodiment of the invention, there is provided a system for facilitating an optical cross-connection from a first region to a second region, the system comprising: a first collimator body and a second collimator body adjustably positioned at the first region and the second region, respectively, the first collimator body and the second collimator body each having a proximal end and a distal end, respectively, the proximal end of the first collimator body and the proximal end of the second collimator body being oriented toward one another; first support means and second support means for adjustably supporting the first collimator body at a center of mass thereof and the second collimator body at a center of mass thereof, respectively; and first adjustment means and second adjustment means for selectively adjusting the position of the first collimator body from the first position to a third position and the second collimator body from the second position to a fourth position.

In another embodiment of the invention, there is provided a method for selectively positioning a collimator body, the method comprising: supporting the collimator body relative to a first position; and adjusting the collimator body from the first position to a second position, using adjustment means comprising an actuator component having a driver coil and a magnetic structure with a first gap formed therebetween, one of the driver coil and the magnetic structure being in attachment to the selectively positionable collimator body and the other one of the driver coil and the magnetic structure being in attachment to a fixed support in connection with the support means adjustably supporting the collimator body, wherein an electrical current through the driver coil of the at least one actuator component causes the collimator body to move in a direction perpendicular to a magnetic field created by the magnetic structure of the at least one actuator component.

In another embodiment of the invention, there is provided a method for facilitating an optical cross-connect from a first region to a second region, the method comprising: providing a first collimator body and a second collimator body adjustably positioned at the first region and the second region, respectively, the first collimator body and the second collimator body each having a proximal end and a distal end, respectively, the proximal end of the first collimator body and the proximal end of the second collimator body being oriented toward one another; supporting the first collimator body at a first position and the second collimator body at a second position, respectively; adjusting the first collimator body from the first position to a third position and the second collimator body from the second position to a fourth position, using first adjustment means and second adjustment means, respectively, the first adjustment means and the second adjustment means each comprising an actuator component having a driver coil and a magnetic structure with a gap formed therebetween, one of the driver coil and the magnetic structure of the first adjustment means being fixedly attached to the first collimator body and the other one of the driver coil and the magnetic structure of the first adjustment means being fixedly attached to the first support means, one of the driver coil and the magnetic structure of the second adjustment means being fixedly attached to the second collimator body and the other one of the driver coil and the magnetic structure of the second adjustment means being fixedly attached to the second support means; determining a relative position of the first collimator body and a relative position of the second collimator body, respectively; and applying a first electrical current to the driver coil of the first adjustment means based on the relative position of the first collimator body, and applying a second electrical current to the driver coil of second adjustment means based on the relative position of the second collimator body.

In another embodiment of the invention, there is provided a method for facilitating an optical cross-connection from a first region to a second region, the method comprising: providing a first collimator body and a second collimator body adjustably positioned at the first region and the second region, respectively, the first collimator body and the second collimator body each having a proximal end and a distal end, respectively, the proximal end of the first collimator body and the proximal end of the second collimator body being oriented toward one another; supporting the first collimator body at a center of mass thereof and supporting the second collimator body at a center of mass thereof; and adjusting the position of the first collimator body from the first position to a third position and the second collimator body from the second position to a fourth position.

### BRIEF DESCRIPTION OF THE DRAWINGS

These and other objects and features of the present invention will be more fully disclosed by the following detailed description of the preferred embodiments of the invention, which is to be considered together with the accompanying drawings wherein like numbers refer to like parts and further wherein:

FIGS. 1A, 1B and 1C illustrate a preferred embodiment of the present invention comprising an array of collimators, which are shown oriented in a rest position;

FIGS. 2A, 2B and 2C illustrate the array as shown in FIGS. 1A, 1B and 1C, with a pair of the collimators rotated to make a connection;

FIGS. 3A and 3B illustrate a preferred embodiment of the present invention comprising one set of magnetic actuators used to rotate a collimator, wherein the coils are elongated along the axis of the collimator;

FIGS. 4A and 4B illustrate an alternative preferred embodiment of the present invention comprising a magnetic actuator suitable for large angles, wherein the planes of the coils are perpendicular to the collimator axis;

FIG. 5 shows another alternative preferred embodiment of the present invention similar to that shown in FIG. 4;

FIG. 6 illustrates a detail of a preferred embodiment of a set of hinges used to adjustably anchor a collimator;

FIG. 7 shows a mode spectrum of a preferred embodiment of the collimator actuator; and

FIG. 8 shows a schematic of a preferred embodiment of a circuit used for position sensing.

### DETAILED DESCRIPTION OF THE PREFERRED EMBODIMENTS

Both small-scale, and scale-free, space switching fabrics are important with respect to the development of all optical networks. By avoiding costly electrooptical converters, enhanced performance is provided at a decreased cost.

Items that are of importance for an optical network switching fabric are the size of the fabric, the average insertion loss per connection, the variation in insertion loss, the polarization dependent loss (PDL loss) for each connection, the bandwidth of the system, the static and dynamic cross-coupling between ports, and the flue cost of the system per port. It is highly desirable to have a system that is large, has a low insertion loss, has a very low PDL loss, and has a very low cost per port.

While micro mirror systems have several advantages for very large systems, such as those above 256×256, these advantages are diminished when smaller systems are considered, such as those that might be prevalent in some all-optical networks of the near future.

More particularly, insertion loss becomes a very important factor if the full fiber (100-200 wavelengths), or substantial wavelength bands of the fiber, are switched, as this involves the loss of optical power over many wavelengths at the same time.

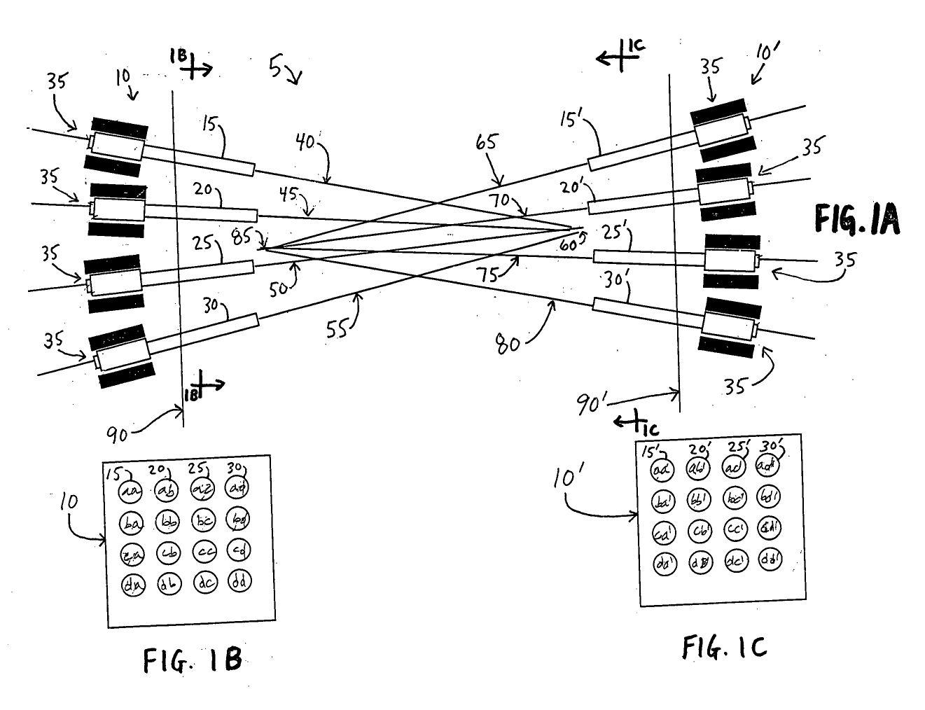

Referring to FIGS. 1A, 1B, and 1C, in a preferred embodiment of the present invention, there is provided a cross-connect system 5 having a first array 5 and a second array 5′ of precision collimators 15, 20, 25, 30 and precision collimators 15′, 20′, 25′, 30′, respectively. Array 5 and array 5′ are each arranged in such a way that precision collimators 15, 20, 25, 30 and precision collimators 15′, 20′, 25′, 30′, respectively, can be oriented with great precision towards each other by servo controlled precision mechanisms. In this configuration, the loss associated with a connection is simply the insertion loss associated with two collimators, which is a very low loss. Typically, such losses are lower than 1 dB and, with care, such losses can be less than 0.5 dB. By using a dual gimbal system, it is possible to position the collimator (and the associated driving coils) with its center of mass at the coincidence of the two rotation axes, and provide great suppression, if not full isolation, for lateral vibrations.

FIG. 1A illustrates a schematic side view of array 10 and array 10′. FIGS. 1B and 1C schematically illustrates a two dimensional front view of array 10 and array 10′, respectively. Array 10 of a transmission portion of cross-connect system 5 shows four rows of collimators 15, 20, 25, 30 arranged in an array aa through dd (FIG. 1B). Likewise, array 10′ of a receiving side of cross-connect system 5 shows four rows of collimators 15′, 20′, 25′, 30′, which are arranged in an array aa′ to dd′ (FIG. 1C). An actuator coil and magnet assembly 35 are operatively connected with each collimator 15, 20, 25, 30 of array 10 and each collimator 15′, 20′ 25′, 30′ of array 10′, respectively. The spacing between actuator coil and magnet assemblies 35 is adjusted such that the collimators can move freely over the desired deflecting angles.

Undeflected beams 40, 45, 50, 55, exiting from collimators 15, 20, 25, 30 are arranged to converge toward point 60, which is in the center of the exit plane of the opposite collimators 15′, 20′, 25′, 30′. A symmetrical arrangement holds true for the orientation of collimators 15′, 20′, 25′, 30′ in that undeflected beams 65, 70, 75, 80 converge toward point 85, which is in the center of the exit plane of the opposite collimators 15, 20, 25, 30.

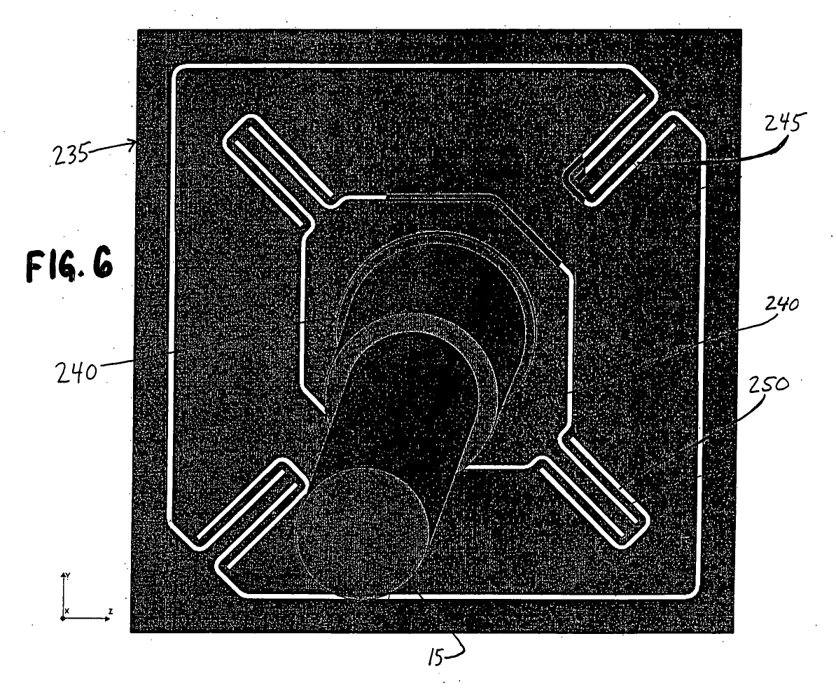

A plate 90 comprises several sets of two dimensional gimbals (FIG. 6) for the deflection of collimators 15, 20, 25, 30 of array 10. Plate 90′ on the opposite side of system 5 comprises several sets of two dimensional gimbals (FIG. 6) for the deflection of collimators 15′, 20′, 25′, 30′ of array 10′. The sets of two dimensional gimbals of plate 90 and plate 90′ allow gross adjustment of collimators 15, 20, 25, 30 and collimators 15′, 20′, 25′, 30′ with respect to one another. Their operation and construction are described in detail hereinbelow.

The optical axis of each collimator is made to coincide with its center of rotation at plate 90 or plate 90′. This configuration permits beam rotation without causing any translation during the rotation of a set of collimators, e.g., collimator 15 and collimator 30′. The convergent arrangement of collimators 15, 20, 25, 30 and collimators 15′, 20′, 25′, 30′, respectively, reduces by half the required angle of deflection that is needed in both directions. For example, collimator 15 and collimator 30′ are each rotated until beam 40 and beam 80 are in alignment with one another, thereby allowing beam 40 to enter collimator 30′, or beam 80 to enter collimator 15, if the direction of the light beam is reversed.

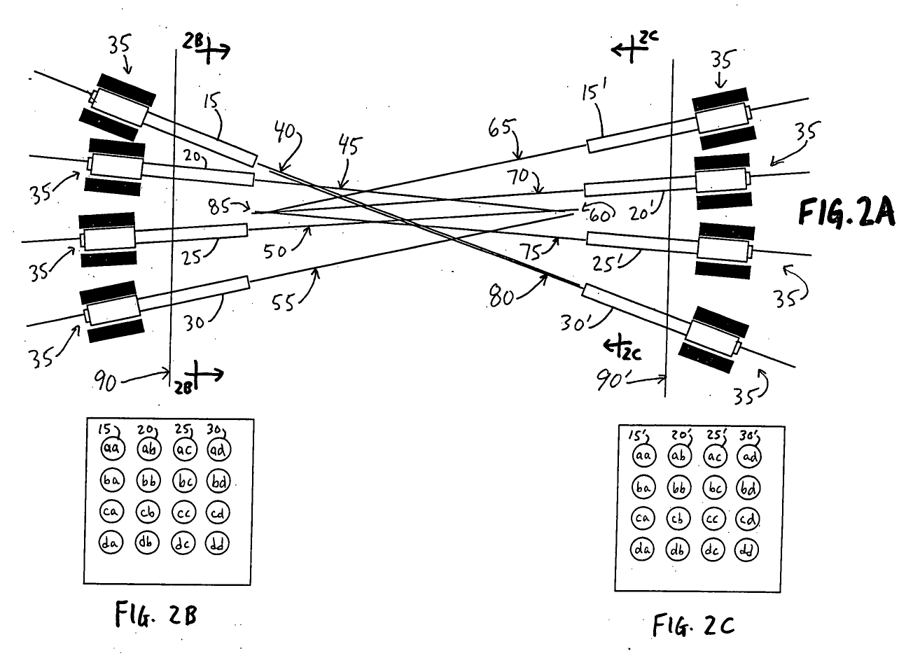

Referring now to FIG. 2A, collimator 15 and collimator 30′ are shown in alignment with one another after appropriate rotation from the configuration shown in FIG. 1A. Once a connection is made, an optical feedback loop (not illustrated) is used to adjust its set point. In a preferred embodiment of the present invention, the magnets of assembly 35 are stationary and the coils of assembly 35 rotate together with collimators 15 and 30′.

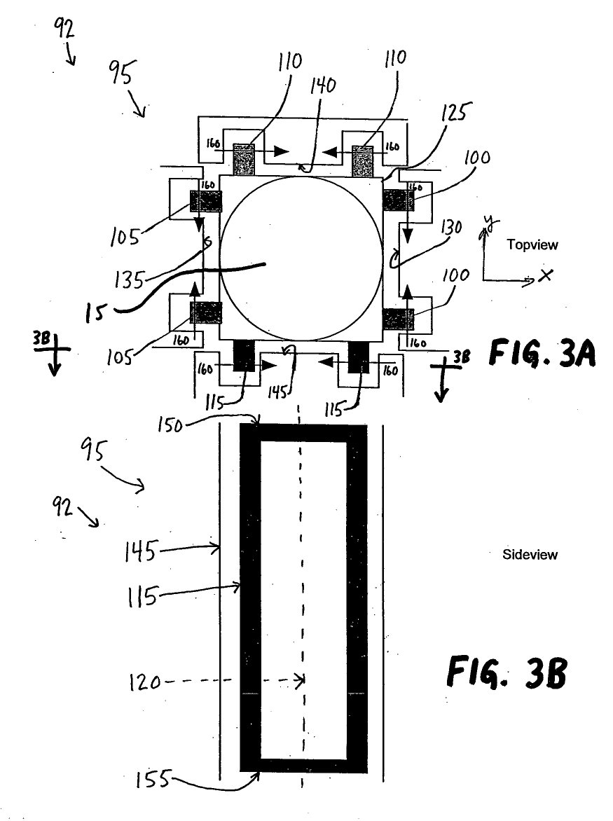

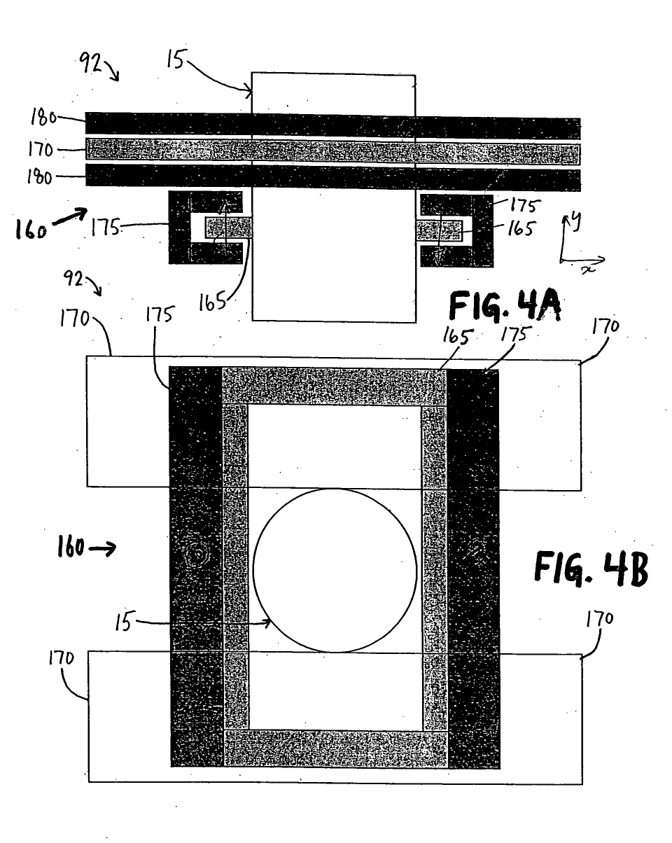

Referring now to FIGS. 3A, 3B, 4A and 4B, in a preferred embodiment of the present invention, there is provided a sensor system 92 for providing a position feedback system of one of the collimators, e.g., collimator 15. Sensor system 92 operates in conjunction with an optical feedback loop (not shown) that analyzes light flowing through cross-connect system 5 between two of the collimators, e.g., collimator 15 and collimator 30′ (see FIG. 2A). Alternatively, sensor system 92 may operate independently of, or in the absence of, an optical feedback loop (not shown). Such a system requires no high voltages, thus making its driving circuitry easily integratable and low cost.

Referring to FIGS. 3A and 3B, in a preferred embodiment of the present invention, there is provided a coil arrangement 95 having a first coil 100, a second coil 105, a third coil 110, and a fourth coil 115 disposed lengthwise along a longitudinal axis 120 of collimator 15. A frame 125 attaches coils 100, 105, 110, 115 to collimator 15. In a preferred embodiment of the present invention, the coils 100, 105, 110, 115 are elongated in the direction of axis 120 so as to maximize the torque and minimize the lateral extend of collimator 15. Magnetic structures 130, 135, 140, 145 are mounted adjacent to coils 100, 105, 110, 115, respectively, with a gap disposed therebetween. The actuators operate on the voice coil principle. Coils 100, 105, 110, 115 are surrounded by magnetic fields perpendicular to the path of current flow.

In an alternative embodiment of the present invention, the top and bottom ends 150, 155 may be removed for simplicity (as used herein, the terms “top” and “bottom” are intended to be understood in the context of the orientation shown in FIG. 3B). The direction of the local magnetic fields are indicated by arrows 160. For example, if coil 100 is actuated it will move perpendicular to the orientation of the local field of magnetic structure 130. This produces collimator rotation in the x-direction. Coil 105, when actuated properly at the same time as coil 100, produces augmented motion in the x-direction. Likewise, coils 110 and 115 when actuated alone, or in tandem, produce motion in the y-direction.

In a preferred embodiment of the present invention, magnetic structures 130, 135, 140, 145 are made of permanent magnets and magnetic keeper material so as to create a gap field as high as possible, as is well known to those skilled in the art. The gap between magnetic structures 130, 135, 140, 145 and coils 100, 105, 110, 115, respectively, is configured wide enough to accommodate the rotation of the collimator 15 as it rotates around its axis in the x-direction and the y-direction. Because the motion of collimator 15 is conical with respect to the rotation point, the required distance between coils 100, 105, 110, 115 and magnetic structures 130, 135, 140, 145, respectively, increases along the length of each coil from top end 150 to bottom end 155, which in turn decreases the magnetic field.

In a preferred embodiment of the present invention (not shown), magnet structure 145 and coil 115 may be tapered with respect to longitudinal axis 120. The gap between coil 115 and magnetic structure 145 is decreased at top end 150 of coil 115, which is near the rotation point, and increased at the bottom end 155, so as to accommodate the larger travel of the distal end of collimator 15.

Referring now to FIGS. 4A and 4B, in another preferred embodiment of the present invention, there is shown an actuator device 160 with coils 165 and 170 attached to collimator body 15, and magnetic structures 175 and 180 in surrounding configuration to coils 165 and 170, respectively. Magnetic structures 175 and 180 produce magnetic fields that are generally perpendicular to the current flowing in coils 165 and 170. Actuation of coil 165 produces motion of collimator body 15 in the x-direction, while actuation of the coil 170 produces motion of collimator body 5 in the y-direction. Because these motions are each in a plane that coincides with the plane of coils 165 and 170, the vertical air gap between the coils 165 and 170 and the magnetic structures 175 and 180, respectively, can be quite small. This configuration allows high magnetic fields and magnetic torques.

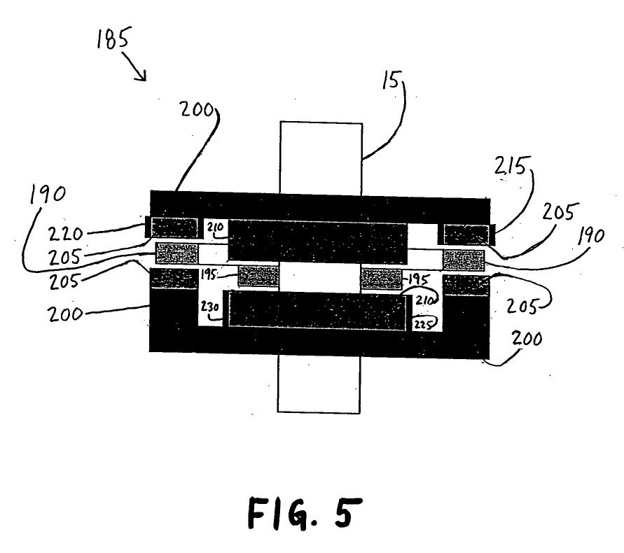

Looking now at FIG. 5, in another preferred embodiment of the present invention, there is shown an actuator device 185 having coils 190 and 195 configured on top of each other, and a magnetic structure 200 built around coils 190 and 195 so as to serve both coils 190 and 195 at the same time. This configuration allows for a compact arrangement of coils 190 and 195 and magnetic structure 200, thereby providing for an almost equal torque on both axes with equal current and dissipation. Here, collimator 15 is surrounded by magnetic structure 200 that includes magnetic paths for magnets 205 and 210. Magnets 205 and 210 provide fields that are perpendicular to coils 190 and 195, respectively. This allows lateral motion in two independent directions, while maintaining small air gaps between magnets 205 and 210 and coils 190 and 195, respectively, which gives rise to a strong field and hence requires only modest drive currents. Coils 215 and 220 provide an inductive sensor for the motion of coil 190. Coils 225 and 230 provide for sensing of the motion of coil 195. Differential readout of the output of coils 215 and 220 provides a voltage that is almost linear with the displacement of primary coil 190 when excited at high frequencies.

In both of these cases, the area of coils 215 and 220 is restricted as much as possible in order to create a cell as small as possible. Each cell consists of a collimator, e.g. collimator 15, a set of coils 190 and 195, and the magnetic structure 205 and 210 attached to the surrounding cell wall (not shown). The cell walls (not shown) form a rectangular honeycomb array of intersecting lines. The honeycomb cells (not shown) are aligned with, and converge toward, the convergence point 60, 85 (FIG. 1A), respectively, of each array 10, 10′ of collimators 15, 20, 25, 30 and collimators 15′, 20′ 25′, 30′, respectively. The typical convergence angle of a cell is 0.8 degrees, with each successive collimator outward from the center of the array having an increasing convergence angle, i.e., by 0.8 degrees.

Now looking at FIG. 6, in a preferred embodiment of the present invention, there is provided a sheet 235 having a hole 240, and hinges 245 and 250, therein. Collimator 15 rotates along two orthogonal axes. These degrees of freedom are provided as collimator 15 is disposed through hole 240 and is adjustably supported by sheet 235. Hinges 245 and 250 provide two degrees of freedom for rotation in two orthogonal directions. As illustrated, hinges 245 and 250 are of the folded type, and provide increased lateral stiffness for the same rotational stiffness. Hole 240, and hinges 245 and 250, are typically etched, simultaneously, in one large sheet for supporting multiple collimators (e.g. 64 or 256 collimators).

In a preferred embodiment of the present invention (not shown), sheets 235 are fabricated by stacking together several ones of sheet 235 and then machining the stacked sheets 235 by electrical discharge machining (EDM). When etched, hole 240 may be etched in several sections that fold away upon insertion of the collimator such that the resulting flaps are used to attach collimator 15 to sheet 235.

Still referring to FIG. 6, in a preferred embodiment of the present invention, several sets of hinges 245 and 250 are etched into a flat sheet of metal so as to form plate 90 or 90′ (FIG. 1A) comprising several sets of dual gimbal and attachment means. Hinges 245 and 250 are etched inexpensively with great precision so as to thereby provide a very economical cross-connect system 5. Cross-connect system 5 can operate in very adverse environmental conditions with very little interference. The beams of arrays 10 and 10′ are made to converge during fabrication so as to decrease the required angle of deflection.

Sheet 235 may be made out of any suitable metal such as stainless steel, titanium, etc. In a preferred embodiment of the present invention, sheet 235 is a few mils thick. Typically, hinges 245 and 250 may be 1.7 mm long, with a 200 micron wide center hinge and 100 micron wide return hinges. With a typical aluminum collimator, which is about 2.8 mm in diameter and about 18 mm in length, the torsional resonance frequencies in both axes are on the order of 50 to 60 Hz. The next higher mode, which consists of vertical pumping mode, is in the neighborhood of 250-300 Hz.

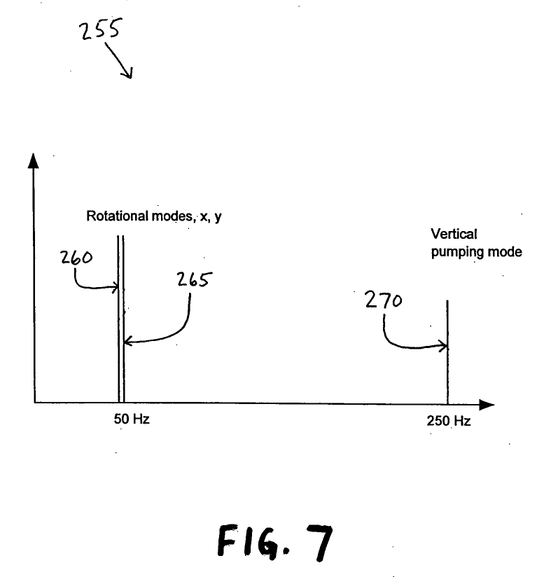

Referring now to FIG. 7, in a preferred embodiment of the present invention, there is shown a mode spectrum 255. This is a very desirable mode spectrum for actuation of an actuator assembly 35 (FIG. 1A), with the lowest torsional modes 260 and 265 (FIG. 7) being very well separated from the next higher order mode 270, which is perpendicular to the rotational control directions. While it is also possible to use hinges of different types which include, for example, bending hinges, generally the resonant spectra are not as desirable, and are not as well separated as in the preferred embodiment of the present invention. It is highly desirable to have the torsional spectra well separated from the next mode, and to have the next mode as one where the collimator does not rotate and, hence, does not greatly affect the established optical link. Since the next mode is a vertical pumping mode, it affects the coupling between collimators very little and, hence, it is of little consequence. Higher modes involving transverse motion of the hinge structures are typically in the neighborhood of 800 to 2000 Hz, which is well separated from the frequencies used in control system.

During assembly, in order to orient the collimators in the appropriate convergent direction, collimators 15, 20, 25, 30 (or collimators 15′, 20′, 25′, 30′) are positioned in a second, thick aligned guiding plate (not shown), which has an array of conical holes oriented such that the desired convergence is forced on array 10 of collimators 15, 20, 25, 30 (or array 10′ of collimators 15′, 20′, 25′, 30′). Hinges 245 and 250 remain undeflected during insertion, and collimator 15 is then glued in place at hole 240. The convergence plate (not shown) is removed after collimator 15 is positioned at the correct orientation.

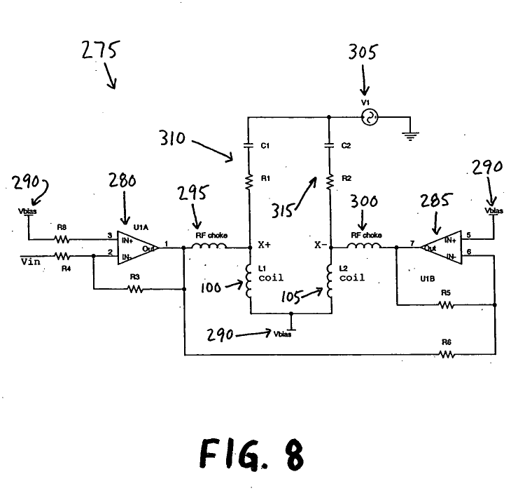

In another preferred embodiment of the present invention, and referring now to FIG. 8, there is shown a sensor arrangement 275 for independently measuring the angular deflection of collimator 15 (FIG. 3A) about its axes. This may be accomplished in a variety of ways. Referring to FIG. 3A, the inductance of coil 100 increases as coil 100 moves in the x-direction toward magnetic structure 100, and the inductance of coil 105 decreases at the same time as coil 105 moves in the x-direction away from magnetic structure 135. Hence, the x-position of coils 100 and 105, and the angular position of collimator 15, are derived by measuring the differential inductance of coils 100 and 105. Likewise, the differential inductance of coils 110 and 115 gives a measure of the y-position of collimator 15. There are several systems, which are well known in the art, that may be used to deduce a sensing signal from this differential output. Coils 100, 105, 110, 115 are operated under DC power so as to produce deflection, while coils 100, 105, 110, 115 may also be operated under AC current at high frequencies such as, for example, several MHz, so as to produce sensing signals without affecting the drive of the actuator assembly.

Referring again to FIG. 8, there is shown sensor arrangement 275 having driver amplifiers 280 and 285 in the same integrated circuit and operating in a push-pull arrangement, respectively. Coil 100 and coil 105 each have a lead connected to a bias voltage 290, also referred to hereinbelow as Vbias 290. For example, a typical bias voltage, Vbias 290, is 2.5 vdc. The other end of coil 100 and coil 105 are driven by driving amplifiers 280 and 285 through RF chokes 295 and 300, respectively. The driver outputs swing symmetrically around Vbias 290, providing a bipolar current in each coil 100 and 105 for positioning collimator 15 (see FIG. 3A). An RF source 305, V1, is applied to coil 100 and coil 105 through the RC networks 310 and 315. The RF chokes act to keep the driver decoupled from the coils at RF frequencies. The circuit comprising coil 100, RC network 310, coil 105, and RC network 315 forms a bridge excited by V1 305. The bridge output at X+320 and X−325 will have a differential AC output that depends on the bridge balance. As the inductance of coil 100 and the inductance of coil 105, respectively, change with position, the bridge output at X+320 and X−325, respectively, will vary in amplitude and polarity. Well-known methods such as synchronous demodulation use the reference AC signal 305 to recover position information from the bridge output at X+320 and X−325. This method provides a very high S/N ratio that is advantageous with small signals in such an environment. The circuitry is duplicated for the y-axis.

In another preferred embodiment of the present invention (not shown), and referring again to FIG. 5, at least one of drive coils 190 and 195 is also supplied with an RF signal, and the sensing coils 215 and 220 are wound on the magnetic structure 200. By taking the difference between the induced RF signals in the coils, it is possible to measure the position of the collimator 15 in the x-direction. A similar arrangement may also be applied in the y-direction so as to provide full position encoding.

1. Apparatus for selectively positioning a fiber-optic collimator body, the apparatus comprising:
support means adjustably supporting the fiber-optic collimator body relative to a first position; and
adjustment means for selectively adjusting the fiber-optic collimator body from the first position to a second position, the adjustment means comprising an actuator component having a driver coil and a magnetic structure with a first gap formed therebetween, one of the driver coil and the magnetic structure being in attachment to the selectively positionable fiber-optic collimator body and the other one of the driver coil and the magnetic structure being in attachment to a fixed support in connection with the support means adjustably supporting the fiber-optic collimator body;
wherein an electrical current through the driver coil of the at least one actuator component causes at least a portion of the fiber-optic collimator body to move in a direction perpendicular to a magnetic field created by the magnetic structure of the at least one actuator component.

2. Apparatus according to claim 1 wherein the driver coil of the actuator is attached to the fiber-optic collimator body.

3. Apparatus for selectively positioning a collimator body, the apparatus comprising:
support means adjustably supporting the collimator body relative to a first position; and
adjustment means for selectively adjusting the collimator body from the first position to a second position, the adjustment means comprising an actuator component having a driver coil and a magnetic structure with a first gap formed therebetween, one of the driver coil and the magnetic structure being in attachment to the selectively positionable collimator body and the other one of the driver coil and the magnetic structure being in attachment to a fixed support in connection with the support means adjustably supporting the collimator body;
wherein an electrical current through the driver coil of the at least one actuator component causes the collimator body to move in a direction perpendicular to a magnetic field created by the magnetic structure of the at least one actuator component;
wherein the driver coil of the actuator is attached to the collimator body, and wherein four driver coils of the actuator component are attached to the collimator body.

4. Apparatus according to claim 3 further comprising a frame mounted between the collimator body and the four driver coils of the actuator component.

5. Apparatus for selectively positioning a collimator body, the apparatus comprising:
support means adjustably supporting the collimator body relative to a first position; and
adjustment means for selectively adjusting the collimator body from the first position to a second position, the adjustment means comprising an actuator component having a driver coil and a magnetic structure with a first gap formed therebetween, one of the driver coil and the magnetic structure being in attachment to the selectively positionable collimator body and the other one of the driver coil and the magnetic structure being in attachment to a fixed support in connection with the support means adjustably supporting the collimator body; and
inductive sensor means for sensing the position of the driver coil and the magnetic structure relative to one another;
wherein an electrical current through the driver coil of the at least one actuator component causes the collimator body to move in a direction perpendicular to a magnetic field created by the magnetic structure of the at least one actuator component.

6. Apparatus according to claim 5 wherein the inductance sensor means comprises a sensor coil mounted relative to the driver coil with a second gap therebetween.

7. Apparatus according to claim 6 wherein the sensor coil is mounted to the magnetic structure of the actuator component.

8-21. (canceled)

22. A method for selectively positioning a fiber-optic collimator body, the method comprising the steps of:
supporting the fiber-optic collimator body relative to a first position; and
adjusting the fiber-optic collimator body from the first position to a second position, using an adjustment structure comprising an actuator component having a driver coil and a magnetic structure with a first gap formed therebetween, one of the driver coil and the magnetic structure being in attachment to the selectively positionable fiber-optic collimator body and the other one of the driver coil and the magnetic structure being in attachment to a fixed support in connection with a support structure configured to adjustably support the fiber-optic collimator body, wherein an electrical current through the driver coil of the at least one actuator component causes the fiber-optic collimator body to move in a direction perpendicular to a magnetic field created by the magnetic structure of the at least one actuator component.

23. A method according to claim 22 further comprising the step of sensing the position of the driver coil and the magnetic structure relative to one another.

24-25. (canceled)

26. An apparatus, comprising:
at least one fiber-optic collimator;
a plate configured to support the fiber-optic collimator and having at least one set of two-dimensional gimbals configured to enable the fiber-optic collimator to be deflected relative to the plate between at least a first position and a second position;
a first actuator component associated with the fiber-optic collimator; and
a second actuator component associated with a support structure to enable the second actuator component to be positioned relative to the first actuator component;
wherein the first and second actuator components are selected such that one of the actor components comprises at least one drive coil and the other actuator component comprises at least one magnetic material.

27. The apparatus of claim 26, wherein the combination of the drive coil and the magnetic material comprise an actuator configured to selectively move the fiber-optic collimator from the first position to the second position.

28. The apparatus of claim 27, wherein the plate has a hole configured to receive the fiber-optic collimator and wherein the gimbals comprise hinges configured to support the fiber-optic collimator and enable the fiber-optic collimator two move relative to the plate in at least two planes.

29. The apparatus of claim 28, wherein the two planes are substantially perpendicular to each other and are also each substantially perpendicular to the plate.

30. The apparatus of claim 28, wherein the hinges support the fiber optic collimator for rotational movement in the two planes about axes substantially coincident with the plate.

31. The apparatus of claim 30 wherein a first pair of hinges connects a portion of the plate surrounding the hole with an intermediate portion of the plate, and wherein a second pair of hinges connects the intermediate portion of the plate with an outer region of an area of the plate surrounding the fiber-optic collimator.

32. The apparatus of claim 28 wherein the hinges are formed by etching through the plate.

33. The apparatus of claim 26, wherein the first actuator component is the drive coil, and wherein the drive coil is attached to the fiber-optic collimator.

34. The apparatus of claim 26, wherein the first actuator component comprises four drive coils attached to the fiber-optic collimator.

35. The apparatus of claim 34, further comprising a frame mounted between the fiber-optic collimator and the four drive coils.

36. The apparatus of claim 26, further comprising at least one sensor configured to sense a position of the drive coil and the magnetic structure relative to one another.

37. The apparatus of claim 36, wherein the sensor comprises an inductive sensor coil mounted relative to the drive coil with a gap formed there between.

38. The apparatus of claim 37, wherein the sensor coil is mounted to the magnetic structure.
